(19) United States
(12) Patent Application Publication
(10) Pub. No.: US 2025/0165337 A1
(43) Pub. Date: May 22, 2025

(54) CONFIGURATION SETTING FOR WIDE AREA SYSTEM PROTECTION

(71) Applicant: Quanta Technology, LLC, Raleigh, NC (US)

(72) Inventor: Eric Avram Udren, Pittsburgh, PA (US)

(21) Appl. No.: 18/953,236

(22) Filed: Nov. 20, 2024

Related U.S. Application Data
(60) Provisional application No. 63/600,757, filed on Nov. 20, 2023.

(51) Int. Cl. G06F 11/07; G06F 16/22

(52) U.S. Cl. CPC G06F 11/0793; G06F 11/0721; G06F 16/2282

(57) ABSTRACT

Protection control equipment of an electrical power system receives synchrophasor measurements. The synchrophasor measurements comprise time-synchronized measurements of current or voltage at respective nodes in the electrical power system. The protection control equipment, based on the synchrophasor measurements, calculates a measurement differential of each of one or more protection zones defined according to a tabular data structure that indicates which nodes in the electrical power system are inter-connected and/or which nodes bound and/or belong to which protection zone. The protection control equipment, for each of the one or more protection zones, controls protection of the protection zone against faults, based on the measurement differential calculated for that protection zone.

### RELATED APPLICATIONS

This application claims the benefit of U.S. Provisional Application No. 63/600,757, filed Nov. 20, 2023, the entire contents of which is incorporated by reference herein.

### TECHNICAL FIELD

The present application relates generally to an electrical power system and relates more particularly to protection of protection zone(s) in such a system.

### BACKGROUND

In an electrical power system, such as an electric transmission grid, phase faults occur when there is an unintended connection between two or more phases, leading to abnormal currents and potential damage to the system components. Ground faults happen when an unintended connection forms between a phase conductor and the ground, causing current to flow through the earth and potentially leading to hazardous conditions and equipment failures.

Protection zones in an electrical power system selectively protect different respective areas or segments of the system from these and other types of faults. A protection zone is a specific area or segment of the power system that is monitored and protected by protective devices such as relays and circuit breakers. When a relay for a zone detects a fault within the zone, the protection system for that zone isolates the zone from the rest of the power system, e.g., by tripping circuit breakers. This selective isolation prevents damage to equipment, maintains system stability, and minimizes disruption by ensuring that only the faulted section is disconnected, while the rest of the power system continues to operate normally.

Different protection zones protect different areas or segments of the power system. For example, different zones may be established around different major pieces of equipment, e.g., generators, transformers, busbars, transmission lines, distribution networks, and motors, each zone being tailored with specific protection schemes to address the unique risks and requirements of the respective zone. Some protection zones may however overlap, to ensure that no part of the system is unprotected.

Each protection zone is primarily protected by protective devices that are locally deployed within that zone in order to enable the quickest possible fault detection and clearance. However, there is a risk that the primary protective devices fail to operate correctly, in which case some faults or abnormal conditions could go undetected or unmitigated by the primary protective devices. So-called backup protection addresses this by providing a second layer of protection as a backup to the primary protective devices. Backup protection conventionally employs distance relays, also known as impedance relays, that detect the occurrence and location of faults based on impedance measurements, e.g., the measured impedance is directly related to the physical distance of a fault along a transmission or distribution line. Backup relays typically have longer operating times compared to primary protection, allowing them to act as a fail-safe mechanism that intervenes only when necessary. They may be strategically implemented to cover overlapping zones of the power system, ensuring comprehensive coverage and enhancing the overall robustness of the power system. By providing redundancy, backup protection helps maintain system stability and continuity of service, even in the event of primary protection failure.

Problematically, though, backup relays may react slower than desired and are unselective, tripping more system elements than the minimum necessary, thereby risking grid instability or blackouts. Furthermore, with increasing penetration of renewable energy generation, there may be insufficient fault current, or fault current of incorrect sequence component signature, so that backup distance relays may not operate and a fault would burn uncleared until blackout. Moreover, backup distance relays are susceptible to stable or unstable swings and could cause unwanted separations of grid areas.

A scheme referred to as wide-area system protection (WASP) aims to mitigate these problems. WASP is a function or use case within the suite of wide-area measurement protection, automation, and control (WAMPAC) functions utilizing time-synchronized (synchrophasor) measurements. See E. A. Udren, Principles for Practical Wide-Area Backup Protection with Synchrophasor Communications, CIGRÉ Session, 2014, Paper B5-112, incorporated by reference herein. WASP employs high-speed time-synchronized current measurements (current synchrophasors) collected across the system at a consolidated processing location. The current measurements are summed according to zones of protection in a current summation or current differential relaying scheme (called 87 in IEEE Standard C37.2 listing of protection function numbers). The scheme evaluates zones of protection that are faulted while applying timing that is coordinated with primary highest-speed local fault protection relays and can trip circuit breakers as needed across the system to remove any observed fault or short circuit. While the scheme can remove any fault, the first objective is to detect faults that are not cleared by the highest-speed local relays or their circuit breakers, and to remove those faults surgically by additional breaker tripping only as required. This backup action is faster than conventional backup relays based on electrical impedance (distance) measurements, will operate correctly for cases where the impedance-based relays fail to respond, and eliminates the undesired operation of unselective backup relays that were not required to remove the fault.

Some ease-of-use challenges however remain for supporting practical implementation of the WASP scheme or other differential protection schemes based on synchrophasors. The fundamental computations for 87 protection are independent of unique transmission line or grid component physical characteristics like electrical impedance. But the scheme requires protection computations to be performed in accordance with the topology or interconnection of zones within the protected area. This challenges application engineers who need to configure the schemes with the required topology so that they can be implemented in practice, especially in systems with complex topologies. Programming unique summations, or changing them whenever the grid evolves, requires excessive effort and retesting.

### SUMMARY

Some embodiments herein facilitate topology-based configuration of a differential protection scheme for protecting zones of an electrical power system. Some embodiments in this regard exploit a tabular data structure (e.g., a table or matrix) for effectively defining protection zones for a differential protection scheme. Such a tabular data structure may indicate which nodes in the electrical power system are inter-connected and/or which nodes bound and/or belong to which protection zones, e.g., in a one-line diagram of the electrical power system. With differential protection software applications configured to ingest the topology of the electrical power system by way of this tabular data structure, some embodiments advantageously enable efficient and effective configuration, and in-service continuing operation, of differential protection schemes that rely on system topology.

More particularly, embodiments herein include a method performed by protection control equipment of an electrical power system. The method comprises receiving synchrophasor measurements that comprise time-synchronized measurements of current or voltage at respective nodes in the electrical power system. The method also comprises, based on the synchrophasor measurements, calculating a measurement differential of each of one or more protection zones defined according to a tabular data structure that indicates which nodes in the electrical power system are inter-connected and/or which nodes bound and/or belong to which protection zone. The method also comprises, for each of the one or more protection zones, controlling protection of the protection zone against faults, based on the measurement differential calculated for that protection zone.

Embodiments herein also include a non-transitory computer-readable storage medium on which is stored instructions that, when executed by one or more processors of protection control equipment of an electrical power system, cause the protection control equipment to receive synchrophasor measurements that comprise time-synchronized measurements of current or voltage at respective nodes in the electrical power system. The stored instructions also cause the protection control equipment to, based on the synchrophasor measurements, calculate a measurement differential of each of one or more protection zones defined according to a tabular data structure that indicates which nodes in the electrical power system are inter-connected and/or which nodes bound and/or belong to which protection zone. The stored instructions also cause the protection control equipment to, for each of the one or more protection zones, control protection of the protection zone against faults, based on the measurement differential calculated for that protection zone.

Embodiments herein also include protection control equipment of an electrical power system. The protection control equipment comprises processing circuitry. The processing circuitry is configured to receive synchrophasor measurements that comprise time-synchronized measurements of current or voltage at respective nodes in the electrical power system. The processing circuitry is also configured to, based on the synchrophasor measurements, calculate a measurement differential of each of one or more protection zones defined according to a tabular data structure that indicates which nodes in the electrical power system are inter-connected and/or which nodes bound and/or belong to which protection zone. The processing circuitry is also configured to, for each of the one or more protection zones, control protection of the protection zone against faults, based on the measurement differential calculated for that protection zone.

### DETAILED DESCRIPTION

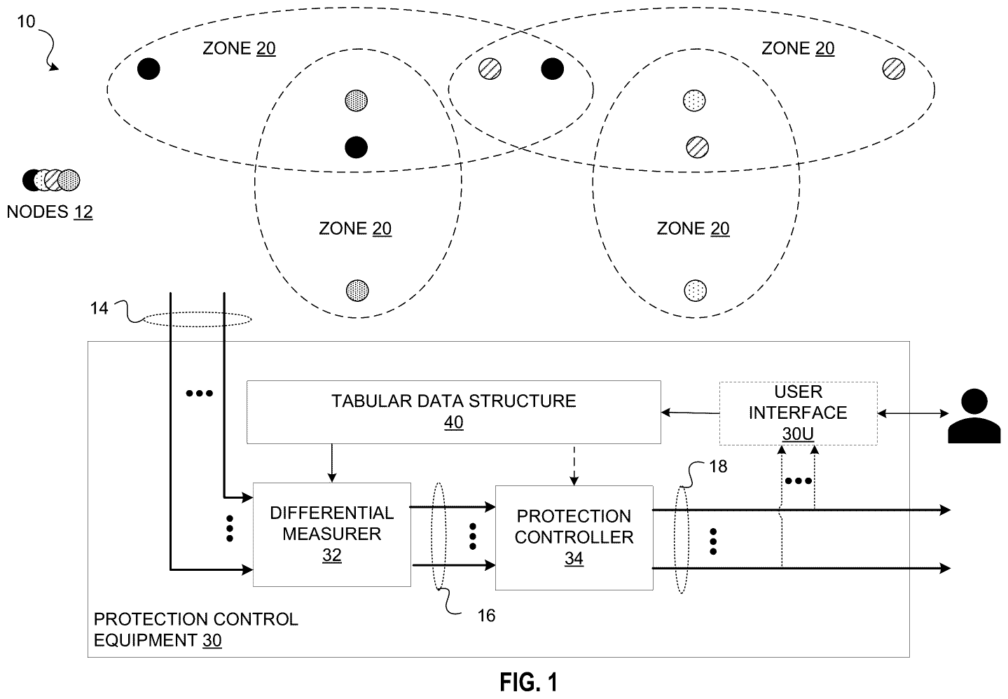

FIG. 1 illustrates a block diagram of an electrical power system and protection control equipment according to some embodiments.

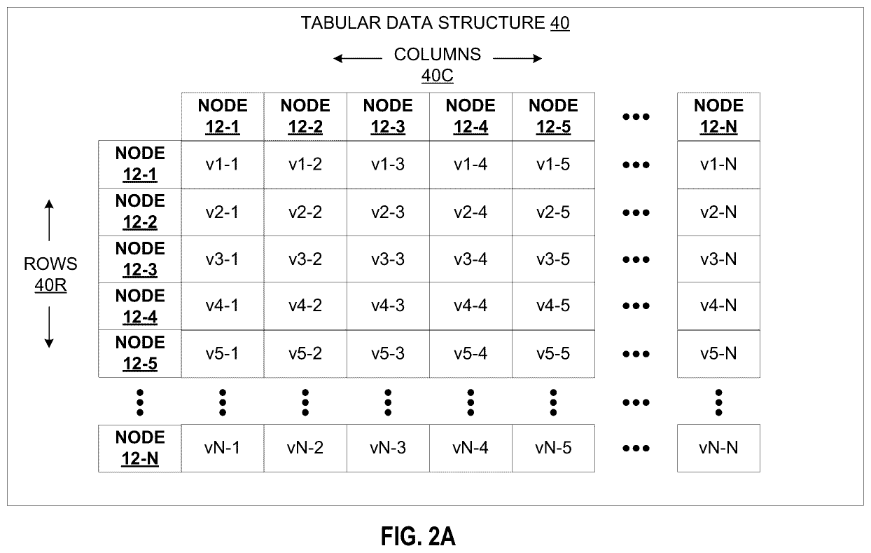

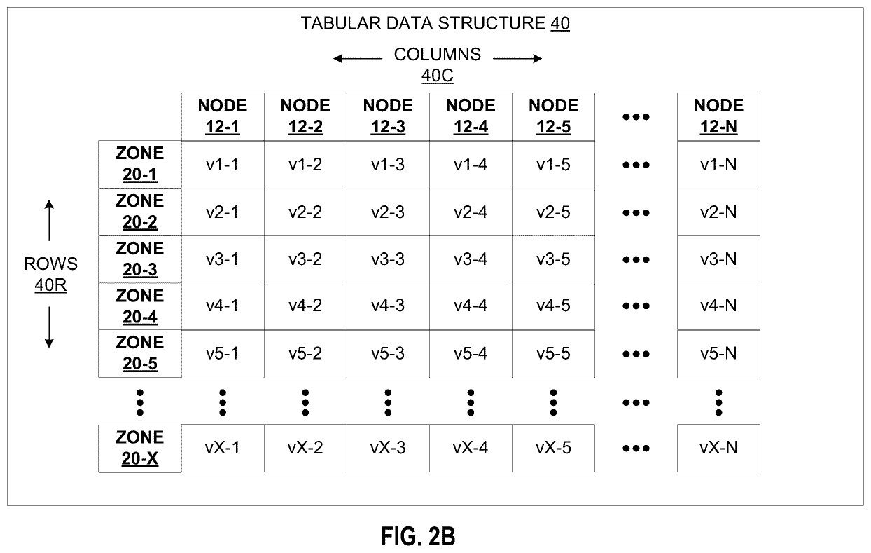

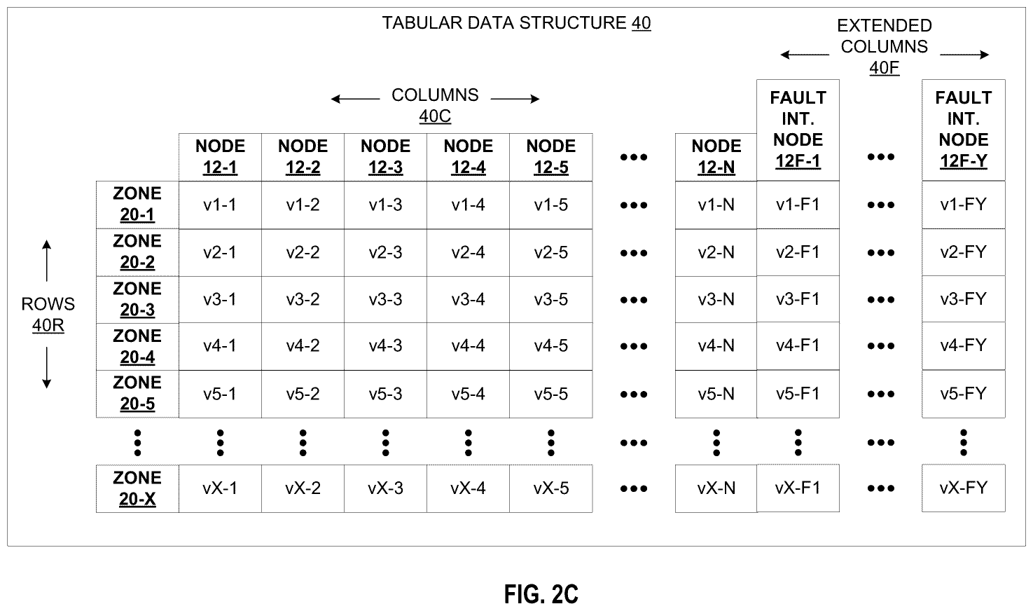

FIGS. 2A-2C illustrate examples of a tabular data structure according to certain embodiments.

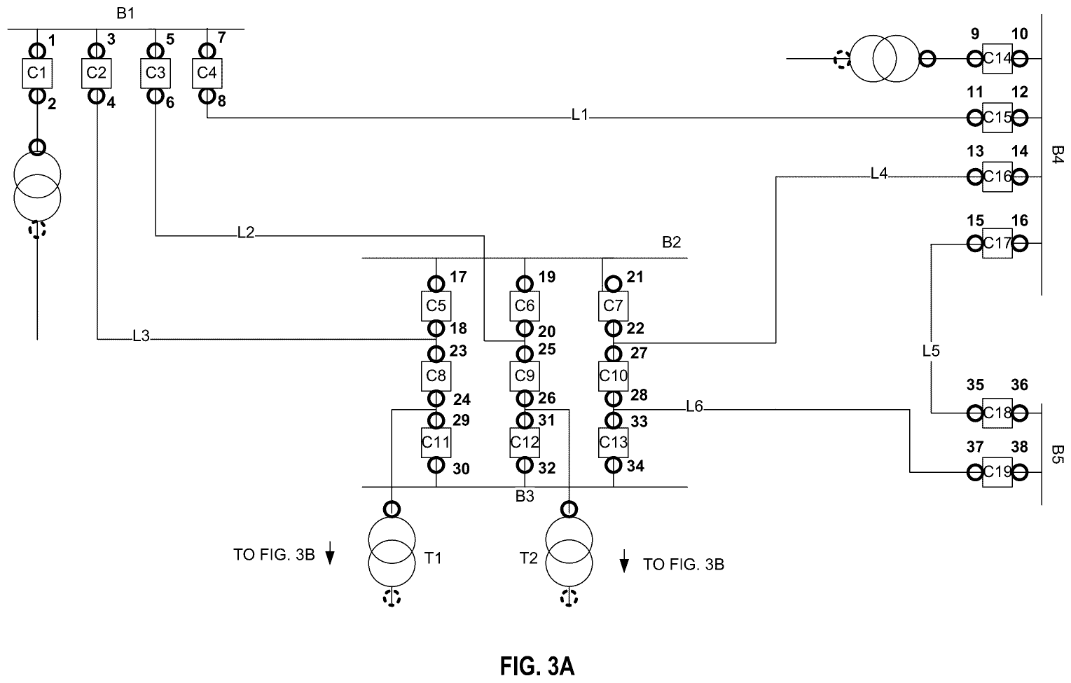

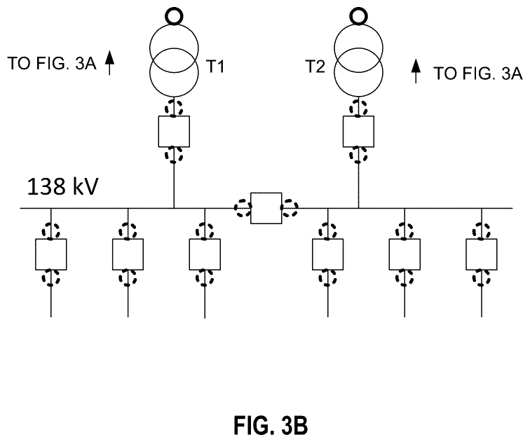

FIGS. 3A-3B illustrate an exemplary single-line diagram of an electrical power system according to certain embodiments.

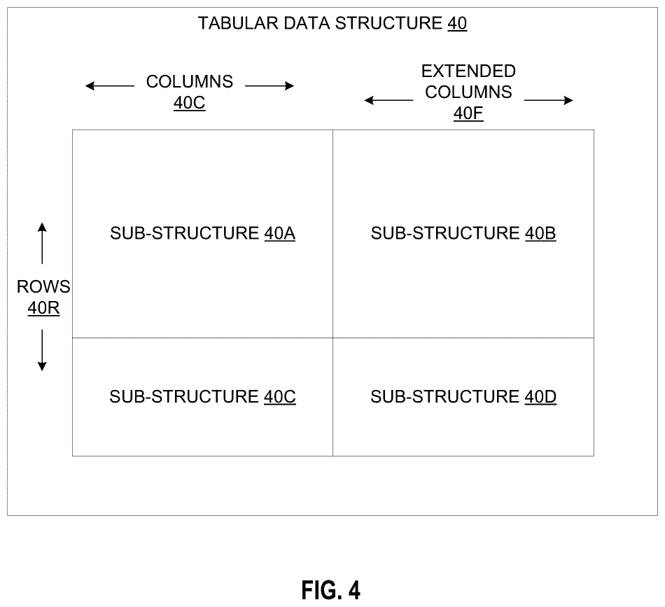

FIG. 4 illustrates an overall tabular data structure for the electrical power system exemplified in FIGS. 3A-3B according to certain embodiments.

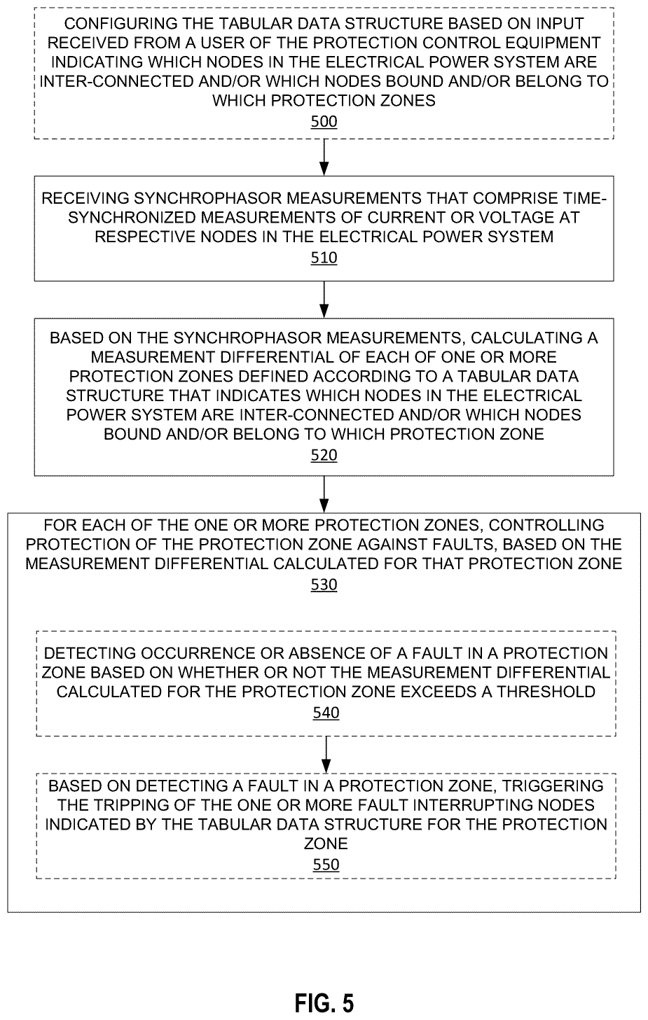

FIG. 5 is a logic flow diagram of a method performed by protection control equipment of an electrical power system in accordance with particular embodiments.

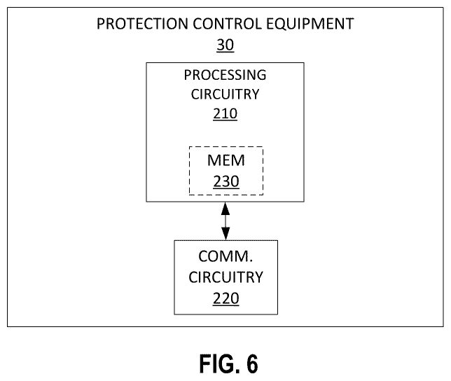

FIG. 6 is a block diagram of protection control equipment of an electrical power system in accordance with particular embodiments.

### DETAILED DESCRIPTION

FIG. 1 shows an electrical power system 10 according to some embodiments, e.g., in the form of an electric utility system or grid. The electrical power system 10 includes multiple nodes 12 whose arrangement and inter-connection defines the system's topology. The nodes 12 may include one or more pieces of equipment or devices that each perform a particular function, e.g., as part of power generation, transmission, or distribution. The piece(s) of equipment or devices may for example include generators, transformers, etc. The piece(s) of equipment or devices may alternatively or additionally include protective devices (e.g., relays) that perform the function of monitoring electrical parameters and/or initiating protective actions, and/or may include fault interrupting devices (e.g., circuit breakers) that perform the function of interrupting a fault that has occurred. The nodes 12 in other embodiments may include one or more buses, lines, or points of interconnection for various electrical components, e.g., in a single-line diagram of the electrical power system 10 and/or corresponding to one or more physical busbars in a substation.

Failure or mis-operation of any given node 12 may however cause a fault in the electrical power system 10. Computing equipment in the form of protection control equipment 30 in FIG. 1 controls, or assists with controlling, protection of the electrical power system 10 against faults, e.g., according to a protection scheme that is based on or dependent on the topology of the electrical power system 10.

According to embodiments herein in this regard, the protection control equipment 30 is notably configurable with a tabular data structure 40, e.g., in the sense that the protection control equipment 30 is configured to ingest, process, and/or otherwise use the tabular data structure 40. The tabular data structure 40 in this regard effectively configures the protection control equipment 30 to control, or assist with control of, protection on the basis of one or more protection zones 20 of the electrical power system 10. Each protection zone 20 is a specific area or segment of the electrical power system 10 that is to be individually monitored for internal faults and selectively isolated upon the occurrence of a fault. Protection zones 20 in some embodiments may overlap.

The tabular data structure 40 in some embodiments indicates which nodes 20 in the electrical power system 10 are inter-connected, i.e., by direct physical connection. FIG. 2A shows one example where the tabular data structure 40 has both a row 40R and a column 40C for each of the nodes 12 in the electrical power system 10. In this example, a value in the tabular data structure 40 that is in a row 40R of values for a first node and that is in a column 40C of values for a second node indicates whether or not the first node is inter-connected with the second node. Referring to FIG. 2A for an example, the value v2-3 indicates whether or not node 12-2 is inter-connected to node 12-3. As another example, the value v5-2 indicates whether or not the node 12-5 is inter-connected with node 12-2. The tabular data structure 40 may thereby effectively capture or represent the system's underlying topology, at least at some level of granularity, e.g., according to a single-line diagram of the electrical power system 10. Protection control equipment 20 in this case may be configured to use the tabular data structure 40 to derive, determine, recognize, or otherwise operate on the basis of the protection zone(s) 20. In these and other embodiments, then, the tabular data structure 40 may at least indirectly define the protection zone(s) 20 for use by the protection control equipment 20.

In other embodiments, the tabular data structure 40 directly defines the protection zone(s) 20. In one or more of these embodiments, the tabular data structure 40 does so by indicating which nodes 20 bound and/or belong to which protection zones 20. The tabular data structure 40 may for example indicate, for each protection zone 20, one or more nodes 12 that are deployed at the boundary of the protection zone 20 and/or that otherwise belong to the protection zone 20. FIG. 2B shows one example where the tabular data structure 40 has rows 40R for protection zones 20 and columns for nodes 12. Here in this example, a value that is in a row of values for a protection zone 20 and that is in a column of values for a node 12 indicates whether or not that node 20 bounds and/or belongs to that protection zone 20. Referring to FIG. 2B for instance, the value v2-3 indicates whether or not node 12-3 bounds and/or belongs to protection zone 20-2. The value v5-2 indicates whether or not the node 12-2 bounds and/or belongs to protection zone 20-5.

In any of these embodiments, though, the tabular data structure 40 enables the protection control equipment 30 to control, or assist with controlling, protection on a protection zone by protection zone basis. For example, configured with the tabular data structure 40, the protection control equipment 30 may control, or assist with controlling, differential protection of the protection zones 20, e.g., according to wide-area system protection (WASP) as described in E. A. Udren, Principles for Practical Wide-Area Backup Protection with Synchrophasor Communications, CIGRÉ Session, 2014, Paper B5-112.

Returning to FIG. 1 in this regard, the protection control equipment 30 is shown as receiving synchrophasor measurements 14, e.g., from one or more of the nodes 12 in the system 10. The synchrophasor measurements 14 comprise time-synchronized measurements of current or voltage at respective nodes 20 in the electrical power system 10. The synchrophasor measurements 14 may for instance be measurements from phasor measurement units (PMUs) that are or are associated with respective nodes 12 in the system 10. PMUs in this regard are electronic functions or devices that stream synchronized measurements at a high rate (e.g., 60 values per second) over a data communications path to the protection control equipment 30 or some other central location that relays the measurements to the protection control equipment 30. PMUs may for example be connected to instrument transformers like current transformers (CTs) in substations or plants. Current synchrophasor values may be computed from CT current waveforms according to industry standard requirements like IEC 60255-118-1-2019 or IEEE C38.118.1-2011.

The protection control equipment 30 further comprises a differential measurer 32 for differential protection of the protection zones 20 using the synchrophasor measurements 14. The differential measurer 32 may for instance be implemented by a real-time application computing platform. Regardless, based on the synchrophasor measurements 14, the differential measurer 32 calculates measurement differential(s) 16 of each of the respective protection zone(s) 20, as those protection zone(s) 20 are defined according to the tabular data structure 40. A measurement differential 16 of a protection zone 20 is a differential between the synchrophasor measurements 14 received from nodes 14 that bound and/or belong to that protection zone 20. For example, in embodiments where the synchrophasor measurements are measurements of current, the measurement differential 16 of a protection zone 20 represents a differential between current entering the protection zone 20 and current leaving the protection zone 20, e.g., with the differential current being zero or close to zero in the absence of a fault but being above a threshold in the presence of a fault. In these and other embodiments, the differential measurement 16 of a protection zone 20 may be computed by summing the synchrophasor measurements 14 received from nodes 14 that bound and/or belong to the protection zone 20. The current synchrophasor measurements in this case may be summed according to zones of protection in a current differential (87) relaying scheme.

The tabular data structure 40 thereby enables the protection control equipment 30 to compute the measurement differential 16 for respective protection zones 20. Indeed, by indicating which nodes 14 are inter-connected and/or which nodes 14 bound and/or belong to which protection zone 20, the tabular data structure 40 informs the differential measurer 32 about from which synchrophasor measurements 14 to compute the measurement differential 16 for any given protection zone 20, namely, the synchrophasor measurements 14 that comprise measurements of current or voltage at nodes 12 that, according to the tabular data structure 40, are inter-connected and/or are bound and/or belong to that protection zone 20. In some embodiments, for example, in order to compute the measurement differential 16 for a given protection zone 20, the differential measurer 32 may use the synchrophasor measurements 14 received from nodes 12 that bound and/or belong to that protection zone 20 according to the tabular data structure 40. In these and other embodiments, then, the nodes 12 indicated in the rows 40R and/or columns 40C of the tabular data structure 40 (as shown in FIGS. 2A and 2B) are synchrophasor measurement nodes that are configured to provide the synchrophasor measurements 14 for use in computing the measurement differential 16 for respective protection zones 20.

The protection control equipment 30 further comprises a protection controller 34 as shown in FIG. 1. For each of the protection zone(s) 20, the protection controller 34 controls, or assists with controlling, protection of the protection zone 20 against faults, based on the measurement differential 16 calculated for that protection zone 20. The protection controller 34 may for instance generate protection signals 18 for controlling, or assisting with controlling, protection of respective protection zones 20.

In some embodiments, for example, the protection controller 34 detects occurrence or absence of a fault in a protection zone 20 based on whether or not the measurement differential 16 calculated for the protection zone 20 exceeds a threshold. In one such embodiment, the protection signal 18 for that protection zone 20 may indicate the presence or absence of a fault in the protection zone 20. The protection controller 34 in one such embodiment may assist with protection of the protection zone 20 by providing this protection signal 18 to a user interface 30U of the protection control equipment 30. In this case, the user interface 30U is correspondingly adjusted to indicate the presence or absence of a fault in the protection zone 20 according to the protection signal 18. This indication may thereby assist an operator of the electrical power system 10 with whether and/or how to handle the presence or absence of a fault in the protection zone 20. For example, if a fault is detected as having occurred in a protection zone 20, the indication on the user interface 30U may inform the operator of this occurrence, either before or after the fault is cleared or isolated. In fact, in some embodiments, the user interface 30U may be adjusted to indicate not only in which protection zone 20 a fault has occurred but also which fault interrupting node(s) are to be or have been tripped to clear a fault in that protection zone 20.

The tabular data structure 40 in some embodiments may equip the protection controller 34 in this regard by indicating which fault interrupting node(s) are to be tripped for isolating which protection zones 20. For example, the tabular data structure 40 may indicate, for each protection zone 20, one or more fault interrupting nodes that are to be tripped upon occurrence of a fault in the protection zone 20 and/or that are within (or at a boundary of) the protection zone 20. FIG. 2C indicates one example of this where the tabular data structure 40 of FIG. 2B is extended with additional columns 40F for fault interrupting nodes 12F-1 . . . 12F-Y to be tripped for different protection zones 20. For example, value v3-F1 indicates whether or not fault interrupting node 12F-1 is to be tripped upon occurrence of a fault in protection zone 20-3, value v5-FY indicates whether or not fault interrupting node 12F-Y is to be tripped upon occurrence of a fault in protection zone 20-5, etc.

Especially equipped with such a tabular data structure 40, the protection controller 34 may alternatively or additionally itself trigger the tripping of fault interrupting node(s) to isolate a detected fault, e.g., so as to realize high-speed protection on the order of tens or hundreds of milliseconds since fault occurrence. In this case, the protection signals 18 may alternatively or additionally be trip signals for respective protection zones 20. A trip signal for a protection zone 20 indicates that the fault interrupting node(s) 20 indicated by the tabular data structure 40 for that protection zone 20 are to be tripped.

Generally, then, the protection control equipment 30 may itself trigger the tripping of fault interrupting node(s) indicated by the tabular data structure 40 for a protection zone 20. Or, the protection control equipment 30 may assist with such tripping to be performed by the system operator, e.g., by indicating on the user interface 30U which fault interrupting node(s) are to be tripped for isolating a fault detected in a protection zone 20.

In any event, the tabular nature of the tabular data structure 40 advantageously enables efficient and effective configuration of the protection control equipment 30, even for systems with complicated system topologies. In fact, the protection control equipment 30 in some embodiments facilitates population of the values in the tabular data structure 40 via user interface 30U. The protection control equipment 30 in such case may configure the tabular data structure 40 based on input received from a user of the protection control equipment 30, with such input indicating which nodes 12 in the electrical power system 10 are inter-connected and/or which nodes 12 bound and/or belong to which protection zones 20.

Note, too, that the tabular data structure 40 is any data structure that arranges data into rows and columns, e.g., so as to facilitate structured representation of that data. Examples of the tabular data structure 40 include one or more matrices, one or more tables, e.g., where each row represents a distinct record and each column represents a specific attribute or field of the data. In embodiments where the tabular data structure 40 includes multiple matrices or multiple tables, for instance, the tabular data structure 40 may include at least one matrix or table per protection zone 20.

Note further that some embodiments include transformers as nodes 12 in the tabular data structure and provide a set of standard transformer types to configure as zones, with associated manipulations of synchrophasor measurements for each type of transformer. Further in this regard, a transformer may have two or more ports that look different so that a cell entry in the tabular data structure 40 may specify which winding is connected to a synchrophasor measurement.

Furthermore, note that the protection implemented by the protection control equipment 30 may be primary protection or backup protection. Primary protection operates as the first line of defense against faults, whereas backup protection operates as a backup to primary protection. In some embodiments, for example, the protection zones 20 are primarily protected by primary highest-speed local protection relays, with the protection control equipment 30 providing backup protection of the protection zones 20 as needed to remove any detected faults that are not cleared by the primary relays, e.g., according to WASP. In this case, embodiments above described as being performed upon occurrence of a detected fault in a protection zone 20 may instead be performed based on the detected fault remaining uncleared after a maximum duration of time allowable for a primary fault clearance node to clear the fault. Backup protection in these embodiments may advantageously operate to surgically remove faults by additional fault interruption only as required. This backup action may be faster than conventional backup relays based on electrical impedance (distance) measurements and may eliminate the undesired operation of these backup relays.

In these and other embodiments, note that the process of receiving the synchrophasor measurements, calculating the measurement differential(s) 16, and controlling of protection may be performed for each of multiple power cycles. Here, a power cycle refers to the time it takes for one complete cycle of an alternating current (AC) waveform. The duration of a power cycle therefore depends on the frequency of the AC power system, e.g., 20 milliseconds for 50 Hz or ˜16.7 milliseconds for 60 Hz. As such, some embodiments herein may detect faults within one or a few power cycles of inception, e.g., assuming P-Class synchrophasors and communication transport times on the order of a power cycle. Here, P-Class is a standard category of filtering specified in IEC 60255-118-1-2019 and IEEE C38.118.1-2011 with a discrete Fourier transform filtering window of about one power cycle, and offering relatively fast response to measurement changes that make WASP work best.

For example, in some embodiments, each time a new set of synchrophasor measurements 14 becomes available (e.g. every 1 power cycle or 16.67 ms), the protection control equipment 30 processes the tabular data structure 40 to know which synchrophasor measurements 14 to add or modify zone by zone and then which fault interrupting node(s) to trip if a non-zero sum indicates the presence of a fault in a zone for more than a specified time.

Consider now a practical example of some embodiments herein as shown in FIGS. 3A-3B. The electrical power system 10 shown in this example consists in relevant part of buses B1-B5, lines L1-L6, three-phase current transformer (CT) sets 1-38, and circuit breakers C1-C19, all arranged according to the topology shown.

FIG. 4 illustrates the overall tabular data structure 40 for the electrical power system 10 exemplified in FIGS. 3A-3B, according to embodiments described in FIG. 2B where the tabular data structure includes rows 40R for protection zones 20 and columns 40C for nodes 12. For purposes of illustration, the tabular data structure 40 is shown as being formed from sub-structures 40A, 40B, 40C, and 40D, the contents of each of which are included and explained below. The tabular data structure 40 may be referred to as a topology configuration table for current differential and breaker failure measurements and tripping, e.g., for 345 kV lines, buses, and breakers.

Table 1 below shows sub-structure 40A. The rows 40R in sub-structure 40A list different protection zones 20, defined as being B1-B5 and L1-L6. The columns 40C list different possible nodes 12 in the form of three-phase current transformers (CTs) 1-38 whose phase synchrophasor streams are available to sum for current differential protection of a protection zone (for each of phases A, B, and C, the protection control equipment 30 sums the residual current for 87 N differential protection). In compliance with conventional protective relaying zone overlap practice, CT connections are defined on the side of a circuit breaker that is opposite from the protection zone 20. For each protection zone 20 represented in a row, the CTs that bound and/or belong to that protection zone 20 are marked with T (true). For example, the CTs that bound and/or belong to the protection zone B1 include CTs 2, 4, 6, and 8. As another example, the CTs that bound and/or belong to the protection zone L1 include CTs 7 and 12. Based on this, protection control equipment 30 sums the synchrophasors for a protection zone from whichever of the CTs are indicated as bounding and/or belonging to that protection zone. In other words, each successive row defines a zone of protection as marked on the one-line diagram by the CT currents marked T which are to be summed.

TABLE 1
Sub-structure 40A

| > | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| B1 | | T | | T | | T | | T | | | | | | | | | | | | |
| B2 | | | | | | | | | | | | | | | | | | T | | T |
| B3 | | | | | | | | | | | | | | | | | | | | |
| B4 | | | | | | | | | T | | T | | T | | T | | | | | |
| B5 | | | | | | | | | | | | | | | | | | | | |
| L1 | | | | | | | T | | | | | T | | | | | | | | |
| L2 | | | | | T | | | | | | | | | | | | | | T | |
| L3 | | | T | | | | | | | | | | | | | | T | | | |
| L4 | | | | | | | | | | | | | | T | | | | | | |
| L5 | | | | | | | | | | | | | | | | T | | | | |
| L6 | | | | | | | | | | | | | | | | | | | | |

| > | 21 | 22 | 23 | 24 | 25 | 26 | 27 | 28 | 29 | 30 | 31 | 32 | 33 | 34 | 35 | 36 | 37 | 38 |
|---|---|---|---|---|---|---|---|---|---|---|---|---|---|---|---|---|---|---|
| B1 | | | | | | | | | | | | | | | | | | |
| B2 | | T | | | | | | | | | | | | | | | | |
| B3 | | | | | | | | | T | | T | | T | | | | | |
| B4 | | | | | | | | | | | | | | | | | | |
| B5 | | | | | | | | | | | | | | | T | | T | |
| L1 | | | | | | | | | | | | | | | | | | |
| L2 | | | | | | T | | | | | | | | | | | | |
| L3 | | | | T | | | | | | | | | | | | | | |
| L4 | T | | | | | | | T | | | | | | | | | | |
| L5 | | | | | | | | | | | | | | | | T | | |
| L6 | | | | | | | | | | | | | | T | | | | T |

Table 2 below shows sub-structure 40B. The rows 40R in sub-structure 40B likewise list different protection zones 20, defined as being B1-B5 and L1-L6. The extended columns 40F list different fault isolation nodes in the form of circuit breakers C1-C19 that are available to trip. For each protection zone 20 in a row, the circuit breakers that are to be tripped upon the occurrence of a fault in that protection zone are marked with T (true). For example, upon occurrence of a fault in protection zone B2, circuit breakers C5, C6, and C7 are to be tripped in order to isolate that protection zone B2. As another example, upon occurrence of a fault in protection zone L3, circuit breakers C2, C5, and C8 are to be tripped in order to isolate that protection zone L3.

TABLE 2
Sub-structure 40B

| | | | | | | | | | | | | | | | | | | | |
|---|---|---|---|---|---|---|---|---|---|---|---|---|---|---|---|---|---|---|---|
| > | C1 | C2 | C3 | C4 | C5 | C6 | C7 | C8 | C9 | C10 | C11 | C12 | C13 | C14 | C15 | C16 | C17 | C18 | C19 |

| | | | | | | | | | | | | | | | | | | |
|---|---|---|---|---|---|---|---|---|---|---|---|---|---|---|---|---|---|---|
| B1 | T | T | T | T | | | | | | | | | | | | | | |
| B2 | | | | | T | T | T | | | | | | | | | | | |
| B3 | | | | | | | | | | T | T | T | | | | | | |
| B4 | | | | | | | | | | | | | T | T | T | T | | |
| B5 | | | | | | | | | | | | | | | | | T | T |
| L1 | | | | T | | | | | | | | | | T | | | | |
| L2 | | | | | | | | | | | | | | | | | | |
| L3 | | T | | | T | | | T | | | | | | | | | | |
| L4 | | | | | | | T | | T | | | | | | T | | | |
| L5 | | | | | | | | | | | | | | | | T | | T |
| L6 | | | | | | | | | T | | | T | | | | | | T |

Table 3 below shows sub-structure 40C. The rows 40R in sub-structure 40B list yet other protection zones 20, in the form of circuit breakers C1-C19 for supporting breaker failure backup protection. For circuit breaker objects as protection zones, the protection control equipment 30 may use the largest synchrophasors from among the CTs marked with T, rather than summing them for differential 87 N protection. In this example, then, the protection zone C4 defined for circuit breaker C4 backup protection includes CTs 7 and 8, whereas the protection zone C10 defined for circuit breaker C10 backup protection includes CTs 27 and 28.

TABLE 3
Sub-structure 40C

| > | 1 | 2 | 3 | 4 | 5 | 6 | 7 | 8 | 9 | 10 | 11 | 12 | 13 | 14 | 15 | 16 | 17 | 18 | 19 | 20 |
|---|---|---|---|---|---|---|---|---|---|---|---|---|---|---|---|---|---|---|---|---|
| C1 | T | T | | | | | | | | | | | | | | | | | | |
| C2 | | | T | T | | | | | | | | | | | | | | | | |
| C3 | | | | | T | T | | | | | | | | | | | | | | |
| C4 | | | | | | | T | T | | | | | | | | | | | | |
| C5 | | | | | | | | | | | | | | | | | T | T | | |
| C6 | | | | | | | | | | | | | | | | | | | T | T |
| C7 | | | | | | | | | | | | | | | | | | | | |
| C8 | | | | | | | | | | | | | | | | | | | | |
| C9 | | | | | | | | | | | | | | | | | | | | |
| C10 | | | | | | | | | | | | | | | | | | | | |
| C11 | | | | | | | | | | | | | | | | | | | | |
| C12 | | | | | | | | | | | | | | | | | | | | |
| C13 | | | | | | | | | | | | | | | | | | | | |
| C14 | | | | | | | | | T | T | | | | | | | | | | |
| C15 | | | | | | | | | | | T | T | | | | | | | | |
| C16 | | | | | | | | | | | | | T | T | | | | | | |
| C17 | | | | | | | | | | | | | | | T | T | | | | |
| C18 | | | | | | | | | | | | | | | | | | | | |
| C19 | | | | | | | | | | | | | | | | | | | | |

| > | 21 | 22 | 23 | 24 | 25 | 26 | 27 | 28 | 29 | 30 | 31 | 32 | 33 | 34 | 35 | 36 | 37 | 38 |
|---|---|---|---|---|---|---|---|---|---|---|---|---|---|---|---|---|---|---|
| C1 | | | | | | | | | | | | | | | | | | |
| C2 | | | | | | | | | | | | | | | | | | |
| C3 | | | | | | | | | | | | | | | | | | |
| C4 | | | | | | | | | | | | | | | | | | |
| C5 | | | | | | | | | | | | | | | | | | |
| C6 | | | | | | | | | | | | | | | | | | |
| C7 | T | T | | | | | | | | | | | | | | | | |
| C8 | | | T | T | | | | | | | | | | | | | | |
| C9 | | | | | T | T | | | | | | | | | | | | |
| C10 | | | | | | | T | T | | | | | | | | | | |
| C11 | | | | | | | | | T | T | | | | | | | | |
| C12 | | | | | | | | | | | T | T | | | | | | |
| C13 | | | | | | | | | | | | | T | T | | | | |
| C14 | | | | | | | | | | | | | | | | | | |
| C15 | | | | | | | | | | | | | | | | | | |
| C16 | | | | | | | | | | | | | | | | | | |
| C17 | | | | | | | | | | | | | | | | | | |
| C18 | | | | | | | | | | | | | | | T | T | | |
| C19 | | | | | | | | | | | | | | | | | T | T |

Table 4 below shows sub-structure 40D. The rows 40R in sub-structure 40B list the other protection zones 20, in the form of circuit breakers C1-C19 for supporting breaker failure backup protection. The columns list adjacent circuit breakers to trip to isolate a failed circuit breaker. For a circuit breaker protection zone in a row, the adjacent breakers to trip to isolate the circuit breaker protection zone are marked with a T (true). For example, for a circuit breaker zone C6, the adjacent breakers to trip to isolate that breaker zone C6 include breakers C3, C5, C7, and C9. The OUT column refers to circuit breaker(s) on the other side of transformer banks that do not have trip connections available in this example for breaker failure backup clearing.

TABLE 4
Sub-structure 40D

| > | C1 | C2 | C3 | C4 | C5 | C6 | C7 | C8 | C9 | C10 | C11 | C12 | C13 | C14 | C15 | C16 | C17 | C18 | C19 | OUT |
|---|---|---|---|---|---|---|---|---|---|---|---|---|---|---|---|---|---|---|---|---|
| C1 | | T | T | T | | | | | | | | | | | | | | | | T |
| C2 | T | | T | T | T | | | T | | | | | | | | | | | | |
| C3 | T | T | | T | | T | | | T | | | | | | | | | | | |
| C4 | T | T | T | | | | | | | | | | | | T | | | | | |
| C5 | | | | | | T | T | T | | | | | | | | | | | | |
| C6 | | | T | | T | | T | | T | | | | | | | | | | | |
| C7 | | | | | T | T | | | | T | | | | | | T | | | | |
| C8 | | T | | | T | | | | | | T | | | | | | | | | T |
| C9 | | | T | | | T | | | | | | T | | | | | | | | T |
| C10 | | | | | | | T | | | | | | T | | | T | | | T | |
| C11 | | | | | | | | T | | | | T | T | | | | | | | T |
| C12 | | | | | | | | | T | | T | | T | | | | | | | T |
| C13 | | | | | | | | | | T | T | T | | | | | | | T | |
| C14 | | | | | | | | | | | | | | | T | T | T | | | T |
| C15 | | | | T | | | | | | | | | | T | | T | T | | | |
| C16 | | | | | | | T | | | T | | | | T | T | | T | | | |
| C17 | | | | | | | | | | | | | | T | T | T | | T | | |
| C18 | | | | | | | | | | | | | | | | | T | | T | |
| C19 | | | | | | | | | | T | | | T | | | | | T | | |

Note that CT polarity of connection or wiring in practical installations are inconsistent and inversion is sometimes needed. In this case, the tabular data structure 40 may use TP and TN or equivalent entries in place of T to tell the protection control equipment 30 that polarity of TN signal is to be inverted (i.e., phasor angles are shifted by 180 degrees).

Furthermore, this example did not include transformer protection. Some embodiments apply protection herein on one voltage tier and leave transformer protection to redundant differential and SP relays. However, other embodiments may span over and include transformers between two tiers. In this case, a zone type indicator may be used in the left column that specifies the transformer connection; e.g. TAU1 for autotransformer bank and TWDG2 for a grounded wye-delta bank. For the latter, the T (or TP or TN) selection of a CT set may need to be TDEL or TWYE so the protection control equipment 30 will know which side is which and how to manipulate phase current phasors in differential protection of the bank. Other common winding configurations may be needed. A ground CT synchrophasor channel may be needed for each bank.

Consider now some embodiments where the tabular data structure 40 may be exemplified as a matrix or table and the protection scheme applied is WASP, i.e., to realize a matrix-based protection configuration scheme for WASP. The matrix, which may be called a sparse node table (SNT) here, is easy for the protection engineer to set up and fill in. In service, a real-time application computing platform may recursively process the addition of the current synchrophasors according to the zones defined in the matrix. If a substantial non-zero current summation shows a fault in a zone, the matrix will indicate to the protection control algorithms the locations of circuit breakers or switching devices that are to be opened to surgically remove the fault.

### SNT Construction

On a one-line or three-line diagram of the grid area to be protected, every node type may be labeled according to the following list. Descriptive information may be added as desired to each node, e.g., using utility company naming standards for convenience.

In the following, PMU is phasor measurement unit—an electronic function or device connected to instrument transformers like current transformers (CTs) in substations or plants. PMUs stream synchronized current measurements at a high rate (e.g., 60 values per second) over a data communications path to the central collection and processing location where embodiments herein are implemented. Current synchrophasor values are computed from CT current waveforms according to industry standard requirements like IEC 60255-118-1-2019 or IEEE C38.118.1-2011.

### Node Types:

1. PMU I-streaming circuit breaker or fault switching device
2. Non-breaker PMU I-stream source such as a line relay
3. Non-streaming circuit switching device for fault interruption
4. Non-streaming circuit isolating device whose state is reported and verified in non-fault operation.
5. Non-streaming circuit isolating device whose state is preconfigured and then verified in non-fault operation (may be combined with previous).
6. Passive edge node, a line or connection to systems adjacent to protected system, with no current phasor streaming or status reporting.
7. Streaming or passive non-switching nodes interfacing through system boundaries like transformer or PAR banks having their own protection, to isolation switching nodes like breakers on the other winding(s) of a transformer.
8. Breaker-side designation for current phasor streams from CTs on each of two sides of a dead-tank circuit breaker.
9. Fault switching devices are labeled as such only if they can be tripped at high speed from the protection control equipment (i.e., IEC 61850 GOOSE or R-GOOSE path or TT path). Otherwise, they are switches whose state is reported, or else preprogrammed and verified.
10. In some embodiments, nodes may also include voltage nodes like buses or lines. These nodes may not be directly used for differential protection, but may be used for swing detection and/or other applications. Also, line voltages may be used for charging current correction to improve 87 sensitivity and security for long lines or cable circuits.

One application approach used here is to consider a transformer bank as an isolation break from another voltage tier of the electric grid, and to protect each transformer locally with its own redundant differential and distance relays. This keeps the scale of the WASP zones tractable. However, WASP can be applied across voltage tiers out to the edges of the electric grid. Some embodiments include transformer zone protection in WASP, and cover the whole multi-tier grid with a redundant WASP array.

In some embodiments, phase angle regulators (PARs) are to have streaming from each side, and separate local protection for the PAR zone itself.

In some embodiments, the tabular data structure 40 may be embodied as a so-called connectivity table and created as follows, to represent the topology of the protection system:
1. List all the N nodes in successive rows, with some indication of type
2. List all the same N nodes in the same order across the columns
3. Every cell has a T or F state for connectivity of the nodes. Starting default is all F (no connections among nodes).
4. Starting with the first node row, look at the system diagram and identify all the adjacent nodes to that first node.
5. Set to T the column states for all the connected adjacent nodes.

The connectivity table may be created in this way based on user input received via the user interface 30U.

Note that every adjacent node has a type which will allow a user and/or the protection control equipment 30 to know what to do with it—for example:
1. Add its current stream to the subject node's currents if relevant for 87/87 N.
2. Trip it for fault isolation if it has a fault break ability or is a fault interrupting device.
3. Perform remote breaker failure monitoring or protection if it is a streaming breaker.
4. Disable adjacent-node zone fault protection if this is a passive edge node.
5. Monitor via adjacent node currents to report apparent state or alarm for incorrect apparent state
6. Trip low-side breakers for a transformer whose high side connects directly to a protected line that suffers a fault.

When fully composed, the table will be somewhat sparse for all but the most extremely meshed systems. But there is no issue whether the table is sparse or densely populated.

Some embodiments may work with multiple interconnected loops, e.g., albeit potentially the backup zone tripping may become more extensive or less surgical.

### Real-Time Protection Processing:

1. System data gathering and stream quality monitoring is a separate system function to be implemented.
2. Run through the node table iteratively every cycle or so with the following analysis.
3. For each node with valid current stream, go to all the adjacent current stream nodes and add up the valid values.
4. If just this is done, each zone will get summed at least twice, and more than twice if there are more than two zone-boundary nodes. Four boundary nodes are typical at EHV.
5. This redundant useless rechecking of zones may be avoided by compiling the protected zones from the node table as a startup process, and then just running each zone once in the once-per-power-cycle protection loop.
6. Apply fault decision logic and primary timing to the sums that are not close to zero.
7. Optionally correct sums for charging current phasors (capacitive charging) when needed or beneficial, determined with voltage and circuit length/shunt admittance for each line differential summation.
8. Why wait to trip if a fault is clearly seen in a zone of protection? WASP will see faults within a few power cycles of inception, assuming P-Class synchrophasors and communications transport times on the order of a power cycle. There is no reason not to trip a few cycles after the primary relays should have tripped, as additional modest-speed redundant primary protection.
9. Apply breaker failure (BF) protection where faults are detected and are expected to be locally cleared. Note that, in the table, the lower half of the table may show breaker measurement and isolation tripping connectivity to support BF protection in a WASP controller. This backs up BF protection that may be present in a substation relaying system.
10. BF and failed relay backup protection—If a fault is not cleared by local relays and/or breakers in acceptable time, parse the node table to find the fault-interrupting nodes adjacent to the breaker node that is not clearing, and trip those.

This is the surgical backup clearing—far more benign for the grid than zone 2 distance relays which will take longer and will trip more breakers than needed.

In view of the modifications and variations herein, FIG. 5 depicts a method performed by protection control equipment 30 of an electrical power system 10 in accordance with particular embodiments. The method includes receiving synchrophasor measurements 14 that comprise time-synchronized measurements of current or voltage at respective nodes 12 in the electrical power system 10 (Block 510). The method also comprises, based on the synchrophasor measurements 14, calculating a measurement differential 16 of each of one or more protection zones 20 defined according to a tabular data structure 40 that indicates which nodes 12 in the electrical power system 10 are inter-connected and/or which nodes 12 bound and/or belong to which protection zone 20 (Block 520). The method also comprises, for each of the one or more protection zones 20, controlling protection of the protection zone 20 against faults, based on the measurement differential 16 calculated for that protection zone 20 (Block 530).

In some embodiments, the tabular data structure 40 indicates which nodes 12 in the electrical power system 10 are inter-connected. In some embodiments, for at least a portion of the tabular data structure 40, a value in the tabular data structure 40 that is in a row 40R of values for a first node 12-1 and that is in a column 40C of values for a second node 12-2 indicates whether or not the first node 12-1 is inter-connected with the second node 12-2.

In some embodiments, for each of the one or more protection zones 20, calculating a measurement differential 16 of the protection zone 20 comprises calculating the measurement differential 16 as a sum of synchrophasor measurements 14 for nodes 12 that, according to the tabular data structure 40, are inter-connected and/or bound and/or belong to the protection zone 20.

In some embodiments, the method further comprises processing the tabular data structure 40 to determine, from the tabular data structure 40, which nodes 12 in the electrical power system 10 bound and/or belong to which protection zone 20.

In some embodiments, said controlling comprises detecting occurrence or absence of a fault in a protection zone 20 based on whether or not the measurement differential 16 calculated for the protection zone 20 exceeds a threshold (Block 540).

In some embodiments, the tabular data structure 40 further indicates, for each of the one or more protection zones 20, one or more fault interrupting nodes 12F-1 . . . 12F-Y that are to be tripped upon occurrence of a fault in the protection zone 20. In other embodiments, the tabular data structure 40 further indicates, for each of the one or more protection zones 20, one or more fault interrupting nodes 12F-1 . . . 12F-Y that are alternatively or additionally within, or at a boundary of, the protection zone 20. In some embodiments, said controlling comprises, based on detecting a fault in a protection zone 20, triggering the tripping of the one or more fault interrupting nodes 12F-1 . . . 12F-Y indicated by the tabular data structure 40 for the protection zone 20 (Block 550). In some embodiments, said triggering is performed also based on the detected fault remaining uncleared after a maximum duration of time allowable for a primary fault clearance node to clear the fault.

In some embodiments, the tabular data structure 40 indicates which nodes 12 bound and/or belong to which protection zone 20. In some embodiments, for at least a portion of the tabular data structure 40, the tabular data structure 40 includes rows 40R for protection zones 20 and columns 40C for nodes 12, wherein a value that is in a row 40R of values for a protection zone 20 and that is in a column 40C of values for a node 12 indicates whether or not the node 12 bounds and/or belongs to the protection zone 20.

In some embodiments, said receiving, calculating, and controlling is performed for each of multiple power cycles.

In some embodiments, the method further comprises configuring the tabular data structure 40 based on input received from a user of the protection control equipment 30 indicating which nodes 12 in the electrical power system 10 are inter-connected and/or which nodes 12 bound and/or belong to which protection zones 20 (Block 500).

In some embodiments, the synchrophasor measurements 14 are current synchrophasor measurements 14 that comprise time-synchronized measurements of current at respective nodes 12 in the electrical power system 10.

In some embodiments, the tabular data structure 40 includes a table or matrix.

Those skilled in the art will also appreciate that embodiments herein further include corresponding apparatus or equipment and computer programs, e.g., for implementing the real-time application computing platform.

For example, embodiments herein may include protection control equipment 30, e.g., comprising communication circuitry and/or processing circuitry for performing one or more of the aspects described herein. The protection control equipment 30 may for instance implement the real-time application computing platform described above.

FIG. 6 in this regard shows protection control equipment 30 according to some embodiments. As shown, protection control equipment 30 includes processing circuitry 210 and communication circuitry 220. The communication circuitry 220 is configured to transmit and/or receive information to and/or from one or more other nodes, e.g., via any communication technology. Via the communication circuitry 220, for example, the protection control equipment 30 may be configured to receive synchrophasor measurements 14. The processing circuitry 210 is configured to perform processing described above, e.g., in FIG. 5, such as by executing instructions stored in memory 230. The processing circuitry 210 in this regard may implement certain functional means, units, or modules.

A computer program comprises instructions which, when executed on at least one processor of protection control equipment 30, cause the protection control equipment 30 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of protection control equipment 30, cause the protection control equipment 30 to perform as described above.

Embodiments further include a computer program product comprising program code portions for performing the steps of any of the embodiments herein when the computer program product is executed by protection control equipment 30. This computer program product may be stored on a computer readable recording medium.

Other embodiments herein may be realized via a cloud computing platform, e.g., whereby the processing in FIG. 5 is offered to a user as a software as a service, or as a platform as a service.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality.

What is claimed is:

1. A method performed by protection control equipment of an electrical power system, the method comprising:
receiving synchrophasor measurements that comprise time-synchronized measurements of current or voltage at respective nodes in the electrical power system;
based on the synchrophasor measurements, calculating a measurement differential of each of one or more protection zones defined according to a tabular data structure that indicates which nodes in the electrical power system are inter-connected and/or which nodes bound and/or belong to which protection zone; and
for each of the one or more protection zones, controlling protection of the protection zone against faults, based on the measurement differential calculated for that protection zone.

2. The method of claim 1, wherein the tabular data structure indicates which nodes in the electrical power system are inter-connected.

3. The method of claim 2, wherein, for at least a portion of the tabular data structure, a value in the tabular data structure that is in a row of values for a first node and that is in a column of values for a second node indicates whether or not the first node is inter-connected with the second node.

4. The method of claim 1, wherein, for each of the one or more protection zones, calculating a measurement differential of the protection zone comprises calculating the measurement differential as a sum of synchrophasor measurements for nodes that, according to the tabular data structure, are inter-connected and/or bound and/or belong to the protection zone.

5. The method of claim 1, further comprising processing the tabular data structure to determine, from the tabular data structure, which nodes in the electrical power system bound and/or belong to which protection zone.

6. The method of claim 1, wherein said controlling comprises detecting occurrence or absence of a fault in a protection zone based on whether or not the measurement differential calculated for the protection zone exceeds a threshold.

7. The method of claim 1, wherein the tabular data structure further indicates, for each of the one or more protection zones, one or more fault interrupting nodes that are:
to be tripped upon occurrence of a fault in the protection zone; and/or
within, or at a boundary of, the protection zone.

8. The method of claim 7, wherein said controlling comprises, based on detecting a fault in a protection zone, triggering the tripping of the one or more fault interrupting nodes indicated by the tabular data structure for the protection zone.

9. The method of claim 8, wherein said triggering is performed also based on the detected fault remaining uncleared after a maximum duration of time allowable for a primary fault clearance node to clear the fault.

10. The method of claim 1, wherein the tabular data structure indicates which nodes bound and/or belong to which protection zone.

11. The method of claim 10, wherein, for at least a portion of the tabular data structure, the tabular data structure includes rows for protection zones and columns for nodes, wherein a value that is in a row of values for a protection zone and that is in a column of values for a node indicates whether or not the node bounds and/or belongs to the protection zone.

12. The method of claim 1, wherein said receiving, calculating, and controlling is performed for each of multiple power cycles.

13. The method of claim 1, further comprising configuring the tabular data structure based on input received from a user of the protection control equipment indicating which nodes in the electrical power system are inter-connected and/or which nodes bound and/or belong to which protection zones.

14. The method of claim 1, wherein the synchrophasor measurements are current synchrophasor measurements that comprise time-synchronized measurements of current at respective nodes in the electrical power system.

15. The method of claim 1, wherein the tabular data structure includes a table or matrix.

16. A non-transitory computer-readable storage medium on which is stored instructions that, when executed by one or more processors of protection control equipment of an electrical power system, cause the protection control equipment to:
receive synchrophasor measurements that comprise time-synchronized measurements of current or voltage at respective nodes in the electrical power system;
based on the synchrophasor measurements, calculate a measurement differential of each of one or more protection zones defined according to a tabular data structure that indicates which nodes in the electrical power system are inter-connected and/or which nodes bound and/or belong to which protection zone; and
for each of the one or more protection zones, control protection of the protection zone against faults, based on the measurement differential calculated for that protection zone.

17. The non-transitory computer-readable storage medium of claim 16, wherein the tabular data structure indicates which nodes in the electrical power system are inter-connected.

18. The non-transitory computer-readable storage medium of claim 17, wherein, for at least a portion of the tabular data structure, a value in the tabular data structure that is in a row of values for a first node and that is in a column of values for a second node indicates whether or not the first node is inter-connected with the second node.

19. The non-transitory computer-readable storage medium of claim 16, wherein the instructions cause the protection control equipment to, for each of the one or more protection zones, calculate a measurement differential of the protection zone comprises calculating the measurement differential as a sum of synchrophasor measurements for nodes that, according to the tabular data structure, are inter-connected and/or bound and/or belong to the protection zone.

20. The non-transitory computer-readable storage medium of claim 16, wherein the instructions further cause the protection control equipment to process the tabular data structure to determine, from the tabular data structure, which nodes in the electrical power system bound and/or belong to which protection zone.

21. The non-transitory computer-readable storage medium of claim 16, wherein the instructions cause the protection control equipment to control protection of a protection zone by detecting occurrence or absence of a fault in a protection zone based on whether or not the measurement differential calculated for the protection zone exceeds a threshold.

22. The non-transitory computer-readable storage medium of claim 16, wherein the tabular data structure further indicates, for each of the one or more protection zones, one or more fault interrupting nodes that are:
to be tripped upon occurrence of a fault in the protection zone; and/or
within, or at a boundary of, the protection zone.

23. The non-transitory computer-readable storage medium of claim 22, wherein the instructions cause the protection control equipment to control protection of a protection zone by, based on detecting a fault in a protection zone, triggering the tripping of one or more fault interrupting nodes that are indicated by the tabular data structure for the protection zone.

24. The non-transitory computer-readable storage medium of claim 23, wherein the instructions cause the protection control equipment to trigger the tripping of the one or more fault interrupting nodes also based on the detected fault remaining uncleared after a maximum duration of time allowable for a primary fault clearance node to clear the fault.

25. The non-transitory computer-readable storage medium of claim 16, wherein the tabular data structure indicates which nodes bound and/or belong to which protection zone.

26. The non-transitory computer-readable storage medium of claim 25, wherein, for at least a portion of the tabular data structure, the tabular data structure includes rows for protection zones and columns for nodes, wherein a value that is in a row of values for a protection zone and that is in a column of values for a node indicates whether or not the node bounds and/or belongs to the protection zone.

27. The non-transitory computer-readable storage medium of claim 16, wherein the instructions cause the protection control equipment to perform said receiving, calculating, and controlling for each of multiple power cycles.

28. The non-transitory computer-readable storage medium of claim 16, wherein the instructions further cause the protection control equipment to configure the tabular data structure based on input received from a user of the protection control equipment indicating which nodes in the electrical power system are inter-connected and/or which nodes bound and/or belong to which protection zones.

29. The non-transitory computer-readable storage medium of claim 16, wherein the synchrophasor measurements are current synchrophasor measurements that comprise time-synchronized measurements of current at respective nodes in the electrical power system.

30. The non-transitory computer-readable storage medium of claim 16, wherein the tabular data structure is a table or matrix.

31. Protection control equipment of an electrical power system, the protection control equipment comprising:
processing circuitry configured to:
receive synchrophasor measurements that comprise time-synchronized measurements of current or voltage at respective nodes in the electrical power system;
based on the synchrophasor measurements, calculate a measurement differential of each of one or more protection zones defined according to a tabular data structure that indicates which nodes in the electrical power system are inter-connected and/or which nodes bound and/or belong to which protection zone; and
for each of the one or more protection zones, control protection of the protection zone against faults, based on the measurement differential calculated for that protection zone.
